(19) United States
(12) Patent Application Publication
(10) Pub. No.: US 2002/0114937 A1
(43) Pub. Date: Aug. 22, 2002

(54) Insulated barriers and methods for producing same

(76) Inventors: Donald F. Albert, Higganum, CT (US); Greg R. Andrews, Middletown, CT (US); Joseph W. Bruno, Higganum, CT (US); Robert S. Mendenhall, Middlefield, CT (US)

Correspondence Address: FISH & NEAVE, 1251 AVENUE OF THE AMERICAS, 50TH FLOOR, NEW YORK, NY, 10020-1105, US

(21) Appl. No.: 09/997,582

(22) Filed: Nov. 29, 2001

Related U.S. Application Data
(63) Continuation-in-part of application No. 09/972,163, filed on Oct. 4, 2001.
(63) Continuation-in-part of application No. 09/809,793, filed on Mar. 16, 2001, now abandoned.
(60) Provisional application No. 60/253,795, filed on Nov. 29, 2000.
(60) Provisional application No. 60/195,165, filed on Apr. 6, 2000.

(51) Int. Cl. B32B 1/04; B32B 3/02; B32B 3/26; B32B 3/00

(52) U.S. Cl. 428/304.4; 428/69

(57) ABSTRACT

An insulated barrier comprising first and second gas impermeable rigid walls, preferably of a composite of an organic substrate, such as plastic, coated with an inorganic matrix, such as a metal oxide, adjoining surfaces between the first and second walls in order to create an entirely closed and substantially hermetically sealed structure, a core material between the walls comprising an open-cell structure and an optional vacuum breach sensor within the insulated barrier by which the presence of atmospheric oxygen may be detected. Also disclosed is a process by which insulated barriers may be manufactured in accordance with the present invention.

### RELATED APPLICATIONS

This application claims priority from U.S. Provisional patent application Ser. No. 60/253,795, filed Nov. 29, 2000 and U.S. patent application Ser. No. 09/972,163, filed Oct. 4, 2001, which claims priority from U.S. patent application Ser. No. 09/809,793, filed Mar. 16, 2001, which claims priority from U.S. Provisional patent application Ser. No. 60/195,165, filed Apr. 6, 2000, the disclosures of which are incorporated herein by reference.

### FIELD OF THE INVENTION

The present invention relates generally to insulated barriers for temperature-sensitive or thermally-controlled applications. More particularly, the present invention relates to evacuated insulated barriers comprising a substantially gas-impermeable and rigid encapsulating structure with an insulating core material that is formed in situ within the encapsulating structure and that supports the walls of the encapsulating structure. This invention also relates to methods for producing such insulated barriers.

### BACKGROUND OF THE INVENTION

In many industries, accurate and long-lasting temperature control within packaging, storage, and transportation systems is crucial. Such temperature-sensitive applications include, for example, refrigeration equipment and insulated products for the consumer market, and containers for the shipment and storage of biomedical products. In some applications, such as the shipment of biomedical products, the temperature must be controlled at sub-zero or cryogenic conditions. However, existing shipping and storage containers, which are typically made of pre-formed polystyrene or polyurethane core materials, provide inadequate insulation and require a substantial quantity of coolant, such as dry ice. In addition, they are often expensive and non-disposable. And, while the overall thermal conductivity of a thermally insulating device can be further decreased by increasing the thickness of the insulating material, the effectiveness of the insulator decreases significantly as the surface area of the device is increased. See, “Common Application Misunderstandings and the Role of Engineering Assistance in Educating the Vacuum Insulation Customer” Vuoto, 28(1-2), pp. 47-50 (January-June 1999).

In general, efforts to enhance the performance of thermal insulation devices have focused on decreasing the thermal conductivity (k) of insulating materials (also expressed in terms of its inverse, “R-value”). The lower the thermal conductivity, the lower the overall heat transfer and thus, the better the insulator. These efforts have focused on the reduction of some, but not all, of the heat transfer mechanisms (heat transfer by solid conduction, heat transfer by gas conduction and heat transfer by radiation), and have not been successful.

For example, there are two basic ways in which heat transfer by solid conduction can be reduced. One way is to decrease the density of the insulating material. The other way involves using an insulating material of low thermal conductivity and making irregular connections within the material so that there is no straight or short path through the material from one side of the insulator to the other. This ‘tortuous path’ method typically means that the solid material also contains small, open cells within it that are separated by irregular shaped and thin-wall sections that resemble a sponge-like material. Thermal insulation devices that reduce solid conduction in these ways have thermal conductivities typically in the range of about 15 to 70 mW/m*K. For example, polystyrene and polyurethane insulation have thermal conductivities of about 23 to 70 mW/m*K which can be further reduced to about 20 mW/m*K by reducing the density. An example of a material that reduces solid thermal conductivity via the tortuous path method is an aerogel. Aerogels can have thermal conductivities as low as approximately 15 mW/m*K.

However, reducing heat transfer by solid conduction in these ways is limited. One limitation is that reducing the density of an insulating material also reduces its mechanical strength. Oftentimes, the insulating material, in addition to providing thermal insulation, is required to contribute mechanical strength and stability to an insulated barrier. Thus, the reduction in mechanical strength limits the extent to which the density may be reduced. A limitation for materials that reduce solid conduction by the tortuous path method, such as aerogels, is that suitable materials for use in thermal insulation systems were not known until applicants' invention of U.S. Patent application Ser. Nos. 09/809,793 and 09/972,163, which are incorporated herein by reference.

Heat transfer by radiation can be reduced by minimizing radiation transfer throughout the material and by minimizing the amount of radiation coming into contact with the insulating material. Radiation transfer through the insulating material can be reduced by using opacifiers. In addition, metal reflectors may be used to reflect radiation away from the insulation. The use of opacifiers and metal reflectors have been observed to reduce the overall thermal conductivity of an insulator. See, “Thermal Properties of Organic and Inorganic Aerogels” Journal of Materials Research, 9(3), pp. 731-738 (1994). Such techniques can reduce the overall thermal conductivity to about 12 to 20 mW/m*K. Examples of materials that reduce heat transfer by minimizing radiation transfer are organic aerogels, opacified aerogels, polystyrene and polyurethane. However, there is still a need to reduce thermal conduction to values below 12 mW/m*K.

Heat transfer by gas conduction results when gas molecules collide with each other and transfer heat from the “hot side” to the “cold side” of a thermal insulator. One method for reducing heat transfer by gas conduction is to evacuate the insulating space. Evacuation reduces the number of gas molecules within the insulating space, thereby decreasing the frequency of collisions with other gas molecules and with the walls of the insulating container. This reduces the heat transfer that occurs across the insulating space. Such techniques are used in vacuum insulation systems and can reduce the overall thermal conductivity to less than about 3 mW/m*K.

One type of vacuum insulation system uses two encapsulating structures, one placed inside the other, with a vacuum between. The vacuum reduces the conduction of heat from one structure to the other and thus, reduces heat transfer by gas conduction. An example of this type of vacuum insulation system is a Dewar flask. In a Dewar flask, the encapsulating structures (i.e., flasks) are made of a gas impermeable material, such as glass, and their surfaces are usually lined with a reflective metal, such as aluminum or silver, to reduce the transfer of heat by radiation. Dewar flasks are commonly used to store liquefied gases, such as liquid nitrogen, and cryogenic material.

Unfortunately, this type of vacuum insulation system is not very versatile. The size and shape of the encapsulating structure must be specially designed so that the walls do not collapse under atmospheric pressure (e.g., thickness and strength of the walls). Additionally, because the walls are not supported in the vacuum space, the shape of the encapsulating structure is limited to round, oval or cylindrical. Further, to maintain its insulation value, the walls must be absolutely impermeable to gas and moisture. This limits the wall material to either specially treated glass or metal, both of which have a tendency to conduct significant amounts of heat at areas where the walls are joined together (i.e., “edge losses”). Moreover, Dewar flasks made of glass tend to be fragile, and those made of metal are expensive and have high solid thermal conductivities.

It would therefore be desirable to develop an encapsulating structure that combines durability (such as that of plastic) with high gas-impermeability (such as that of glass (i.e., a silicon oxide) or metal). One such combination is disclosed in U.S. Pat. No. 4,560,075 (“the '075 patent”). The '075 patent discloses a vacuum flask in which the flask is made from a molded plastic material and coated with metal. However, such a system requires an ultra-high vacuum and plastic that is strong enough to support the flask under atmospheric pressure and under forces encountered in ordinary use. These requirements limit the geometries to those that can be readily achieved, e.g., cylinders with small neck openings. In addition, strengthening the plastic increases thermal heat transfer along the walls of the flask and also, increases the flask's weight.

The combination of plastic and a metal oxide coatings (“glass coatings”) has only recently become possible as a result of technological advances in film deposition processes. See, e.g., U.S. Pat. Nos. 4,847,469; 4,888,199; 5,224,441; 5,364,665 and 5,904,952. However, these processes have not been used to make encapsulating structures for vacuum insulation. Rather, they have primarily been used to make coatings in food and beverage packages, semiconductor coatings, abrasive coatings, and optical components.

Another type of vacuum insulation system uses the system described above, but includes, an insulating material placed within the vacuum space (i.e., the space in between the two flasks). In the case of a Dewar flask, the vacuum space is filled with a radiative shielding material, such as aluminized MYLAR, to decrease the transfer of heat by radiation. Others, like the Dewar-like thermal coffee carafe disclosed in U.S. Pat. No. 5,968,618 (“the '618 patent”), may be partially filled with an insulating material, such as a silica aerogel, and evacuated in areas adjacent to the insulating material.

However, in addition to the deficiencies described above, this type of vacuum insulating system further suffers in that the insulating materials that have been used do not support the walls of the structure. As used herein, the term “support” refers to the ability of an insulating material to provide structural integrity to the wall so that it does not significantly collapse under atmospheric pressure. In the absence of such support, the walls must be sufficiently thick and strong in order to withstand atmospheric pressure. However, increasing the thickness of the walls increases thermal conductivity into the coolant space.

A third type of vacuum insulation system, referred to as vacuum insulation panels (“VIPs”), are formed by wrapping a thin film barrier or envelope around a core material, and then evacuating the enclosed gases. The barrier or envelope is tightly sealed to maintain the vacuum. The core materials used in the VIP provide resistance to heat transfer and also, support the barrier or envelope. In these systems, the barrier or envelope is a non-rigid, gas impermeable material such that the diffusion of gas into the evacuated space is minimized. As used herein, the term “rigid” refers to a structure that is essentially self-supporting in its final shape prior to evacuation and in the absence of core material.

Core materials used in a VIP may be provided in varying thickness and composition. Typically, such materials are open-celled. As used herein, the term “open cell material” refers to a material in which greater than about 80% of the cells or pores are open. Materials in which less than about 80% of the cells or pores are open are referred to as “closed-celled.” The amount of open pores can be calculated by measuring the absorption of liquid nitrogen or by using standard nitrogen gas adsorption measurements (BET analysis) or helium pycnometry means. Recently, Cabot introduced a VIP containing a material known as NANOGEL™ as the core material. See, e.g., http://www.cabot-corp.com/. NANOGEL™ material is a porous solid combining silica, titania and/or carbon. See, e.g., http://www.nanopore.com/Vacuum_Insulation.html. Dow has also introduced VIPs containing an open-cell core material, known as INSTILL. Dow's VIPs contain a substantially open-cell, microcellular polystyrene foam. See, e.g., http://www.dow.com/instill/overvw/ov5.html.

However, the core materials used in VIPs, including NANOGEL™ and INSTILL, have several deficiencies. Manufacture of the VIP requires multiple steps, including a prefabrication step and a fabrication step. In the prefabrication step, the core material is prefabricated into board stock; in the fabrication step, the core material is fabricated into the desired size and shape; and in the final step, the core material is wrapped with a barrier material and evacuated. In the time period between the prefabrication step and the final step, the core material is exposed to the environment and handling, and as a result, may be damaged even before the VIP is made.

Another problem with VIPs is their barrier material. In general, the barrier materials used to make VIPs are either plastics, metallized plastics (often produced by vapor depositions of metals), lamination-produced metal foil/plastic composites, or welded metal foils. See, e.g., U.S. Pat. Nos. 3,993,811; 4,444,821; 4,669,632; 5,376,424; and 5,897,932. Metallized films or metal foils are the main VIP barrier material used with open-celled core materials.

However, each of the known VIP barrier materials suffers from drawbacks. For example, plastics do not fully prevent gas diffusion, and consequently, the shelf life of the VIP is reduced. Similarly, metallized films or metal foils exhibit stress cracks or pinholes, and consequently, the shelf life of the VIP is reduced. Moreover, panels made from these films and foils contain extremely rough surfaces adjacent to the seams and, therefore, gaps remain between panels when they are assembled, e.g., into boxes (i.e., causing edge loss). Also, because the films and foils are not rigid structures, the insulating core materials must be preformed into their final shapes and consequently, secondary manufacturing steps are needed to enclose them within the film or foil encapsulation structure.

Moreover, foils and films also are difficult to seal while being evacuated. For example, metal foil requires sealing techniques such as laser welding, and metallized films are typically heat sealed. In these processes, edge seals contribute to extremely rough surfaces adjacent to the sealed edge. And, face seals are difficult to achieve in a vacuum chamber environment under current manufacturing technologies. Additionally, it is difficult to obtain a flat seam while the foil or film is attached to an evacuation orifice. Furthermore, because the heat sealing process causes damage to the gas-impermeable metal coating of the plastic film, and because the resulting plastic seal is not gas-impermeable, a hermetic seal is not achieved. Finally, there is no known method for producing vacuum insulation systems using metallized films or foils in geometries other than flat, rectilinear panels.

A fourth type of vacuum insulation system is an insulated double walled barrier with a vacuum between the walls. Such vacuum insulated systems contain an insulating material placed within the vacuum space. For example, U.S. Pat. No. 6,168,040 discloses an insulated barrier filled with foamed glass. The insulated barrier disclosed in U.S. Pat. No. 6,244,458 contains a VIP as the insulating material. U.S. Pat. No. 5,971,198 discloses an insulated barrier comprising a pre-formed glass fiber pelt as the insulating material. See also, U.S. Pat. No. 5,797,513. The insulated barrier disclosed in U.S. Pat. No. 5,827,385 is formed by two mating and interfitting vacuum insulation panels that are pressed together. Each panel is made from a thermoformed or vacuum formed gas impermeable sheet plastics material and contains a known insulating material, such as finely divided precipitated powder silica or an open cell rigid foam made from Dow Chemical Company.

However, existing insulated barriers have several problems. First, they often use pre-formed core materials as the insulating material. Using pre-formed core materials limits the size and shape of the insulating barrier. Further, because pre-formed core materials are made independently of the insulating barrier, the insulated barrier requires secondary manufacturing operations. For example, such core materials must be first molded and demolded and then fabricated into the shape required for the intended application, and finally, the fabricated core material must be wrapped (in the case of a VIP) or placed within the insulated barrier.

Another problem with existing insulated barriers is that often the core material does not support the structure. As a result, the walls must be sufficiently thick and strong to prevent the walls from collapsing upon one another due to atmospheric pressure. However, as the thickness of the wall is increased, the thermal conductivity into the coolant space also increases. This limits the choice of materials for the walls and the geometries of the insulated barrier.

In view of the above, there remains a need for an insulation system that provides superior thermal conductivity comprised of gas impermeable rigid walls and a core material that is formed in situ within the walls, and that supports the walls of the structure.

### SUMMARY OF THE INVENTION

It is an objective of the present invention to provide an insulated barrier for thermal applications wherein all three mechanisms of heat transfer are simultaneously reduced. More particularly, it is an objective of the present invention to provide an insulated barrier comprising:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially open-cell structure or composition;

wherein said core material is formed in situ within said walls.

It is another objective of this invention to provide an insulated barrier comprising:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially open-cell structure or composition;

wherein said first substantially gas impermeable rigid wall, said second substantially gas impermeable rigid wall and said adjoining portions comprise a plastic coated with a metal oxide (e.g., a silicon oxide) coating.

It is another objective of this invention to provide an insulated barrier comprising:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially closed-cell structure or composition;

wherein said first substantially gas impermeable rigid wall, said second substantially gas impermeable rigid wall and said adjoining portions comprise a plastic coated with a metal oxide (e.g., a silicon oxide) coating; and

wherein said closed-cell structure or composition is a powder or granular; provided that said closed-cell structure or composition is not foam glass.

It is another objective of this invention to provide an insulated barrier comprising an evacuation-compatible core material component of variable thickness and opacification, and of low solid thermal conduction.

It is a further objective of this invention to provide an insulated barrier wherein the walls of the barrier are evacuated and sealed following the introduction of the insulating core material.

It is a further objective of this invention to provide an insulated barrier comprising a vacuum breach sensor to alert the user to a deleterious breach of the evacuated walls.

It is another objective of this invention to provide a method for producing insulated barriers.

These objectives are merely exemplary and are not intended to limit the scope of the inventions described in more detail below and defined in the claims.

### BRIEF DESCRIPTION OF THE DRAWING FIGURES

The present invention will be better understood by reading the Detailed Description with reference to the accompanying drawing figures, in which like reference numerals denote similar structure and refer to like elements throughout, and in which:

FIG. 1 is a perspective view of a first embodiment of the insulated barrier of the present invention, demonstrating the invention in flat-panel form, and further having a partial breakaway section showing an internal space thereof;

FIG. 1A is a sectional view of a preferred form of a wall of the insulated barrier of the present invention;

FIG. 2 is an exploded perspective view of an alternate form of construction of the first embodiment of the insulated barrier of the present invention, demonstrating the invention in flat-panel form;

FIG. 3 is a perspective view of a second embodiment of the insulated barrier of the present invention, demonstrating the invention in the form of a box comprising a gas impermeable encapsulating structure, and further having a partial breakaway section showing an internal space thereof;

FIG. 4 is an exploded perspective view of an alternate form of construction of the second embodiment of the insulated barrier of the present invention, demonstrating the invention in the form of a box comprising a gas impermeable encapsulating structure, and further having a partial breakaway section showing an internal space thereof;

FIG. 5 is a perspective view of the third embodiment of the insulated barrier of the present invention, demonstrating the invention in the form of a cylindrical gas impermeable encapsulating structure, and further having a partial breakaway section showing an internal space thereof; and

FIG. 6 is an exploded perspective view of an alternate form of construction of the third embodiment of the insulated barrier of the present invention, demonstrating the invention in the form of a cylindrical gas impermeable encapsulating structure, and further having a partial breakaway section showing an internal space thereof.

### DETAILED DESCRIPTION OF THE INVENTION

In order that this invention may be more fully understood, the following detailed description is set forth. However, the detailed description is not intended to limit the inventions that are defined by the claims.

The present invention provides an insulated barrier having a high degree of thermal insulation. The inventive insulated barrier comprises:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially open-cell structure or composition;

wherein said core material is formed in situ within said walls.

As used throughout this application, the terms “wall,” “adjoining surface,” “enclosure,” and “barrier,” along with their plurals, shall define a substantially gas-impermeable rigid encapsulation structure, or an element thereof.

The gas-impermeable rigid walls used in the insulated barriers of the present invention are made from materials that include, but are not limited to, metals; organic substrates coated with an inorganic matrix; metal coated plastics; single and multi-layer plastic barriers; sprayed, sputtered and otherwise deposited gas impermeable materials coated onto a rigid substrate. Preferably, the gas-impermeable rigid walls comprise a multi-layered plastic such as a laminate consisting of sequential layers of high density polyethylene/ethylvinyl alcohol/high density polyethylene. More preferably, the gas impermeable wall comprises an organic substrate coated with an inorganic matrix. Even more preferably, the gas impermeable wall is a plastic coated with a metal oxide coating. See, e.g., U.S. Pat. No. 6,112,695. Yet, even more preferably, the gas impermeable wall is a plastic coated with a silicon oxide coating. Unlike known insulated barriers, the insulated barriers of the present invention contain rigid walls. As a result, they are more robust and durable than those known.

The gas-impermeable walls are preferably made as thin as possible to limit the insulated barrier's solid thermal conductivity and material weight, while remaining rigid. In one embodiment, the gas impermeable walls may be formed from an impact resistant structure. Preferably, the gas impermeable walls comprise a multi-layered plastic with walls that are about 0.005 to about 0.25 inches thick. In a second preferred embodiment, the gas impermeable walls comprise a single layer plastic, with a gas-impermeable coating, with walls that are about 0.005 to about 0.25 inches thick.

Preferably, the substantially gas-impermeable walls have several, and more preferably all, of the following properties:

1. gas permeability less than about 0.01 cc*mil/24 hrs/100 in²/ATM for Oxygen;

2. solid thermal conductivity less than about 200 mW/m/K;

3. high impact resistance;

4. easily fabricated into complex shapes and sizes;

5. relatively inexpensive;

6. easily sealed under vacuum using methods such as sonic, heat, or radio frequency welding.

The core material used in the insulated barrier of the present invention supports the rigid walls and is formed in situ within the barrier walls. Methods for forming core materials in situ are disclosed in U.S. patent application Ser. Nos. 09/809,793 and 09/972,163.

Preferably, the core material comprises a substantially open cell structure, in which at least 80% of the cells or pores are open. More preferably, the core material comprises an open cell structure in which 100% of the cells or pores are open. The core material may be in any shape or size including, but not limited to, thin films, granulars and monoliths.

Thin films and sheets are defined as a coating, less than about 5 mm thick, formed on a substrate. Granulars are defined as comprising particle sizes such that the volume is less than about 0.125 ml. Monoliths are defined as bulk materials having volumes greater than about 0.125 mls, which corresponds to a block of material having a volume greater than about 125 mm³ (i.e., 5 mm×5 mm×5 mm).

Suitable core materials include, but are not limited to, open cell polystyrene, open cell polyurethane and open cell foams. More preferably, the core material comprises small pore area materials, even more preferably, low density microcellular materials, and yet even more preferably, aerogels, which are described in U.S. patent application Ser. Nos. 09/809,793 and 09/972,163. Most preferably, the core material is a monolithic aerogel.

A small pore area material (“SPM”) is a type of foam, which may be thought of as a dispersion of gas bubbles within a liquid, solid or gel (see IUPAC Compendium of Chemical Terminology (2d ed. 1997)). Specifically, and as used herein, an SPM is a foam having a density of less than about 1000 kilograms per cubic meter (kg/m³) and a small pore structure in which the average pore area is less than about 500 μm². Average pore area, as used herein, is the average of the pore areas of at least the 20 largest pores identified by visual examination of images generated by scanning electron microscopy (“SEM”). These pore areas are then measured with the use of ImageJ software, available from NIH.

Organic SPMs are preferred because they typically exhibit lower solid thermal conductivity than inorganic SPMs, and their precursor materials tend to be inexpensive and exhibit longer shelf-lives. Further, they can be opaque (useful to reduce radiative thermal transfer) or transparent, although such opaque foams do not require opacification. See, e.g., “Aerogel Commercialization: Technology, Markets, and Costs,” Journal of Non-Crystalline Solids, vol. 186, pp. 372-79 (1995). As a result, generally, opaque organic SPMs are more desirable, especially for thermal applications in which optical transparency is not desired.

One type of SPM is a low density microcellular material (“LDMM”). Specifically, and as used herein, an LDMM is an SPM having a microcellular structure in which the average pore diameter is less than about 1000 nanometers (nm) which is determined by measuring the average pore area and then calculating the average pore diameter by using the formula: area=π². For example, an average pore area of 0.8 μm² corresponds to an average pore diameter of 1000 nm.

An aerogel is a type of LDMM (and thus it is also an SPM) in which gas is dispersed in an amorphous solid composed of interconnected particles that form small, interconnected pores. The size of the particles and the pores typically range from about 1 to about 100 nm. Specifically, and as used herein, an aerogel is an LDMM (and thus it is also an SPM) in which: (1) the average pore diameter is between about 2 nm and about 50 nm, which is determined from the multipoint BJH (Barrett, Joyner and Halenda) adsorption curve of N₂ over a range of relative pressures, typically 0.01-0.99 (“the BJH method” measures the average pore diameter of those pores having diameters between 1-300 nm and does not account for larger pores); and (2) at least 50% of its total pore volume comprises pores having a pore diameter of between 1-300 nm.

The core material may be provided in a size or shape, limited only by the application (i.e., small box, refrigerator, cargo carrier or large wall).

The core material may further comprise an opacifier, such as carbon black, organic polymers and inorganic oxides, to reduce radiative heat transfer effects as referenced by “Thermal Properties of Organic and Inorganic Aerogels” Journal of Materials Research, 9(3), pp. 731-738 (March 1994). A preferred opacifier is carbon black.

In an alternate embodiment, the insulated barrier of the present invention comprises:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially open-cell structure or composition;

wherein said first substantially gas impermeable rigid wall, said second substantially gas impermeable rigid wall and said adjoining portions comprise a plastic coated with a metal oxide (e.g., silicon oxide) coating.

Preferred core materials of this alternate embodiment include SPMs, LDMMs, aerogels, polyurethane and polystyrene, in monolithic or granular form.

According to this embodiment, the core material may be formed in situ or pre-formed and placed within the gas impermeable walls or encapsulating structure. After such placement, the structure is evacuated and sealed.

In an alternate embodiment, the insulated barrier of the present invention comprises:

(a) a first substantially gas impermeable rigid wall;

(b) a second substantially gas impermeable rigid wall;

(c) adjoining portions between said first and second walls that create an entirely closed and substantially hermetically sealed structure; and

(d) a core material between the walls that supports the walls of the structure, comprising a substantially closed-cell structure or composition;

wherein said first substantially gas impermeable rigid wall, said second substantially gas impermeable rigid wall and said adjoining portions comprise a plastic coated with a metal oxide (e.g., a silicon oxide) coating; and

wherein said closed-cell structure or composition is a powder or granular; provided that said closed-cell structure or composition is not foam glass.

According to this embodiment, the powder or granular is selected from the group consisting of carbon black, fumed silica, sand and the like. Preferably, the powder or granular can be compacted only to the point where the interstitial spaces are evacuable. More preferably, the powders or granulars are strong enough after compaction to support the gas barrier under evacuation.

According to this embodiment, the core material may be formed in situ or pre-formed and placed within the gas impermeable walls or encapsulating structure. After such placement, the structure is evacuated and sealed.

Preferably, the insulated barrier of the present invention has a thermal conductivity from about 10 to about 7.1 mW/m*K. More preferably, the thermal conductivity is from about 7 to about 5.1 mW/m*K, and even more preferably from 5 to about 3.1 mW/m*K, and yet even more preferably from 3 to about 1 mW/m*K.

The insulated barrier of the present invention may optionally comprise a port. The port is either manufactured within the gas-impermeable wall, or is preformed and inserted within the wall after manufacture. Preferably, the port is manufactured within the gas-impermeable wall. The port may be permanently sealed, self-sealed or neither. Preferably, the port is rigid and is easily sealable after evacuation. The location, size and shape of the port are dependent on the intended application.

In an alternate embodiment, the present invention provides an insulated barrier comprising a vacuum breach sensor for detecting the presence of atmospheric oxygen when the vacuum has been compromised. The vacuum breach sensor may be visual or audible.

A visual vacuum breach sensor comprises a nonaqueous ionic liquid and an indicator. Nonaqueous ionic liquids are liquids at room temperature; are substantially viscous; and have essentially no vapor pressure. Nonaqueous ionic liquids useful in this invention are disclosed in U.S. Pat. No. 5,304,615 and International PCT application WO 97/02252. Suitable nonaqueous ionic liquids include, but are not limited to, heterocyclic halides selected from the group consisting of pyridinium halides, pyridazinium halides, pyrazinium halides, imidazolium halides, pyrazolium halides, thiazolium halides, oxazolium halides and triazolium halides, wherein each nitrogen atom in the heterocyclic ring is substituted with a (C1-C6) alkyl, and wherein the heterocyclic ring is optionally substituted with one to five (C1-C6) alkyl groups. Suitable halides are chloride, fluoride, bromide and iodide. Preferably, the nonaqueous ionic liquid is imidazolium halide. More preferably, the nonaqueous ionic liquid is N-ethyl-N′-methylimidazolium chloride or N-butyl-N′-methylimidazolium chloride.

The indicators used in the visual vacuum breach sensor of the present invention are highly soluble in the nonaqueous ionic liquid. Suitable indicators include, but are not limited to, thiazine dyes and indigo dyes. See, e.g., U.S. Pat. Nos. 5,358,876; 4,349,509 and 4,169,811. Thiazine dyes include, but are not limited to, Lauth's Violet, Azure B, Azure C, Methylene Blue, New Methylene Blue and Thionine Blue. Indigo dyes include, but are not limited to, Indigo, Indigo Carmine and Bromo Indigo R. Preferably, the dye is New Methylene Blue.

Preferably, the visual vacuum breach sensor comprises N-butyl-N′-methylimidazolium chloride and New Methylene Blue.

The visual vacuum breach sensor may be provided as a solution within the vacuum space or as a coating on the port, or on a wax-based carrier, wick and the like located within the vacuum space.

In another aspect of this embodiment, the vacuum breach sensor comprises one or more zinc oxide batteries connected to a light-emitting diode or an audible speaker.

The insulated barriers of the present invention may be provided in a variety of forms including, but not limited to, flat panels, box shaped enclosures, cylindrical enclosures and the like depending on the application. The insulated barrier may be used for production of portable coolers, insulated beverage containers, refrigerators, biomedical shipping containers, building walls, water heaters and the like. Preferably, the insulated barrier of the present invention has a single seam, rather than the twelve seams inherent in a box formed from panels.

The figures herein described provide examples of such applications, but do not limit the scope of the invention in any way.

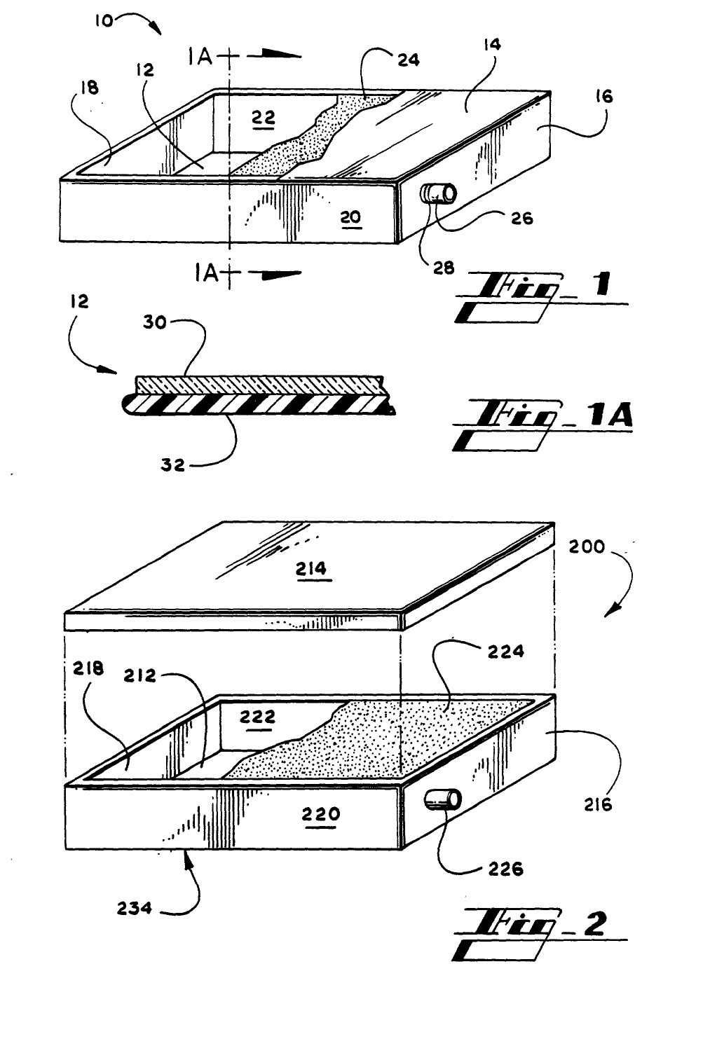

FIG. 1 provides an insulated barrier 10, in the form of a flat panel, having first gas impermeable wall 12, second gas impermeable wall 14, adjoining surfaces 16, 18, 20, 22, core material 24 comprising an open-cell composition or structure, port 26 through which a vacuum may be drawn, and optionally a vacuum breach sensor 28 held within insulated barrier 10 or port 26 by which the presence of atmospheric oxygen may be detected.

As shown in FIG. 1A, first gas impermeable wall 12 comprises inner surface 30 and outer surface 32. Outer surface 32 preferably is an organic substrate, such as plastic, coated with an inorganic matrix, such as a metal oxide, the inorganic matrix forming inner surface 30. It is preferable that the organic substrate be disposed outwardly with regard to insulated barrier 10; that is, towards the direction(s) most susceptible to impact damage.

Second gas impermeable wall 14 is constructed in equivalent and compatible form as first gas impermeable wall 12. Also, it is preferable that the organic portion be disposed outwardly; that is, towards the direction(s) most susceptible to impact damage.

Adjoining surfaces 16, 18, 20, 22 are provided between first and second walls 12, 14 to create an entirely closed and hermetically sealed structure. All adjoining surfaces 16, 18, 20, 22 are of gas impermeable materials, fabricated and oriented in a manner consistent with each other and with first and second walls 12, 14.

Between first and second gas impermeable walls 12, 14 is provided core material 24, preferably comprising an open-cell foam-like structure or composition.

Preferably, one or more of wall 12, 14 or adjoining surface 16, 18, 20, 22 contains port 26 through which a vacuum may be drawn. By connecting a vacuum pump and vacuum tubing to the port, a vacuum may be drawn to evacuate insulated barrier 10 and core material 24.

Insulated barrier 10 or port 26 may also contain a vacuum breach sensor 28 through which the presence of atmospheric oxygen may be detected. Preferably, vacuum breach sensor 28 detects the presence of atmospheric oxygen when the vacuum has been compromised. Accordingly, a user of insulated barrier 10 would be able to readily and certainly determine when to replace insulated barrier 10 in order to preserve the thermal characteristics of insulated barrier 10.

As shown in FIG. 1, the insulated barrier 10 of the present invention may be provided in flat-panel form. In such a form, and with core material 24 formed in situ, the precursor chemicals of core material 24 may be injected into the space or cavity between walls 12, 14 and adjoining surfaces 16, 18, 20, 22, and then processed to its final form. Alternatively, holes, slots, or optionally removable portions of the insulated barrier 10 or adjoining surfaces 16, 18, 20, 22, may be provided which assist formation of the core material 24. Advantageously, evacuation port 26 may be used for filling the cavity and for subsequent formation of the core material. When core material 24 has been formed, the panel barrier, along with core material 24, is evacuated and sealed.

Shown at FIG. 2 is an alternate form of construction of the first preferred embodiment of the present invention in the form of insulated barrier 200. In contrast to insulated barrier 10, insulated barrier 200 is used with core material 224 that is not formed in situ. Accordingly, insulated barrier 200 comprises a flat panel, similar in overall form and material to that just described above, comprising first gas impermeable wall 212 and adjoining surfaces 216, 218, 220, 222, in combination forming bottom portion 234. A second gas impermeable wall in the form of capping portion 214 is provided to complete the enclosure. In use, core material 224 is placed into bottom portion 234, cured and/or compacted if necessary, and capping portion 214 is placed thereover. Bottom portion 234 and capping portion 214 are then sealed. The panel barrier, along with core material 224, is evacuated via port 226 and sealed.

Advantageously, the flat panels described above with regard to FIGS. 1 and 2 may be combined, joined, or otherwise positioned so as to produce more complex structures and devices.

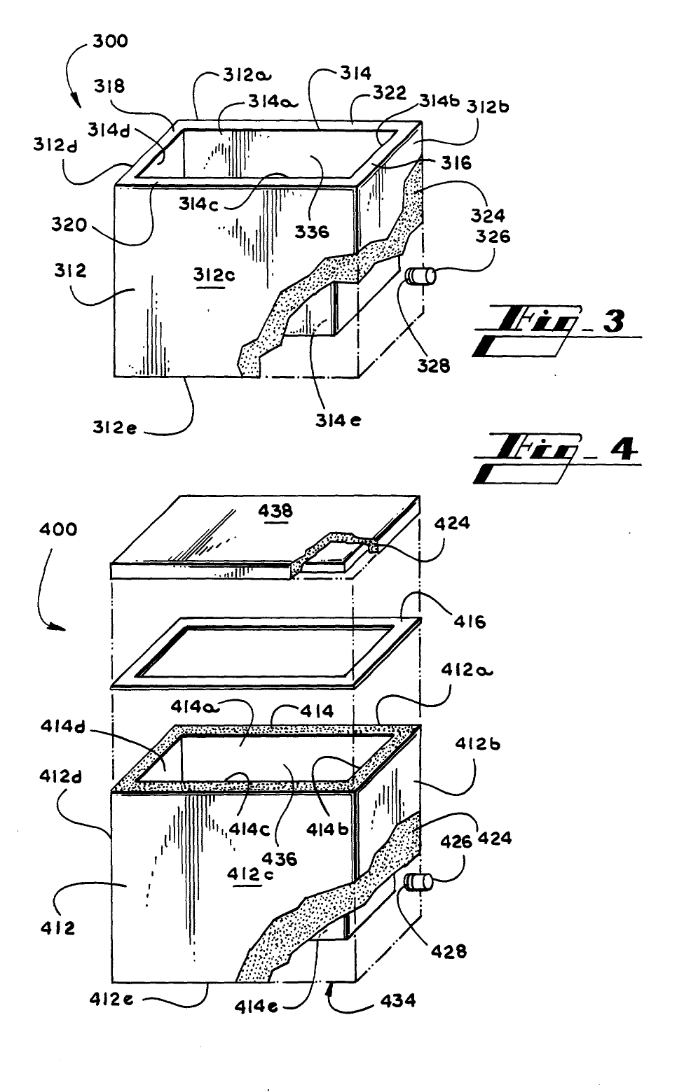

As shown in FIGS. 3 and 4, the insulated barrier of the present invention may be provided in box-like forms, useful for storage, shipment, refrigeration products, or packaging containers. Preferably, such forms include a central cargo or storage cavity, the end result looking much like a conventional box, but having thickened walls.

With reference to FIG. 3, in a second preferred embodiment, provided is insulated barrier 300 in the form of a box-like enclosure, which may comprise a continuous-wall structure. Insulated barrier 300 comprises first gas impermeable wall 312, wall 312 further comprising wall segments 312a, 312b, 312c, 312d, 312e; second gas impermeable wall 314, wall 314 further comprising wall segments 314a, 314b, 314c, 314d, 314e; adjoining surfaces 316, 318, 320, 322; core material 324 comprising an open-cell structure; port 326 through which a vacuum may be drawn; and optionally a vacuum breach sensor 328 held within insulated barrier 300 or port 326 by which the presence of atmospheric oxygen may be detected. In such form, and with the use of core material 324 that may be formed in situ, precursors of core material 324 may be injected into the space or cavity between the gas impermeable walls 312, 314, and adjoining surfaces 316, 318, 320, 322, and then formed. Alternatively, holes, slots, or optionally removable portions of the gas impermeable walls 312, 314, and adjoining surfaces 316, 318, 320, 322, may be provided which assist formation of the core material 324. Advantageously, port 326 may be used for filling the space between the walls and for subsequent formation of the core material 324. When core material 324 has been formed, the insulated barrier 300, along with the core material, is evacuated and sealed. Advantageously to this form, insulated barrier 300 may be constructed so as to include a central cargo or storage cavity 336, the end result looking much like a conventional box, but having thickened walls, and being fully suitable for the carrying of a payload requiring rigorous temperature control. This container form also allows for a single seam instead of the twelve seams that are inherent in a box formed from panels.

Shown at FIG. 4 is an alternate form of construction of the second preferred embodiment of the present invention in the form of a box-like enclosure, intended to be used with a core material not formed in situ. Insulated barrier 400 comprises a box-like enclosure, similar in overall form and material to that described above, comprising first gas impermeable wall 412, wall 412 further comprising wall segments 412a, 412b, 412c, 412d, 412e; second gas impermeable wall 414, wall 414 further comprising wall segments 414a, 414b, 414c, 414d, 414e; capping portion 416; core material 424 comprising an open-cell structure; port 426 through which a vacuum may be drawn; and optionally a vacuum breach sensor 428 held within insulated barrier 400 or port 426 by which the presence of atmospheric oxygen may be detected. Accordingly, walls 412, 414, in combination, form bottom portion 434. In such a barrier, core material 424 is placed into bottom portion 434, formed and/or compacted if necessary, and capping portion 416 is placed thereon. Bottom portion 434 and capping portion 416 are then sealed.

Insulated barrier 400, along with core material 424, is then evacuated and sealed. Again, advantageously to this form, insulated barrier 400 may be constructed so as to include a central cargo or storage cavity 436, cavity 436 being fully suitable for the carrying of a payload requiring rigorous temperature control. As discussed in further detail below, lid 438, fabricated in accordance with the materials and methods of the present invention, may be provided to enclose storage cavity 436. This container form also allows for a single seam instead of the twelve seams that are inherent in a box formed from panels.

It will be apparent to one skilled in the art that a box-like container, of the type just described, appropriately scaled in size, and otherwise substantially as described above, may be outfitted with such apparatus so as to effectively function as a refrigerator or freezer, or combination thereof. Advantageously, the cavity may be linked via the evacuation port with the compressor or alternatively, with a vacuum pump unit substantially as described in U.S. Pat. No. 5,765,379, so that the cavity may be continuously or periodically evacuated, and so as to maintain optimal vacuum conditions within the insulated barrier over long periods of time. Through the use of such continuous or periodic evacuation methods, the walls may be manufactured of a range of semi-permeable gas barrier materials suitable in cost and characteristics to be consistent with the requirements of the consumer market.

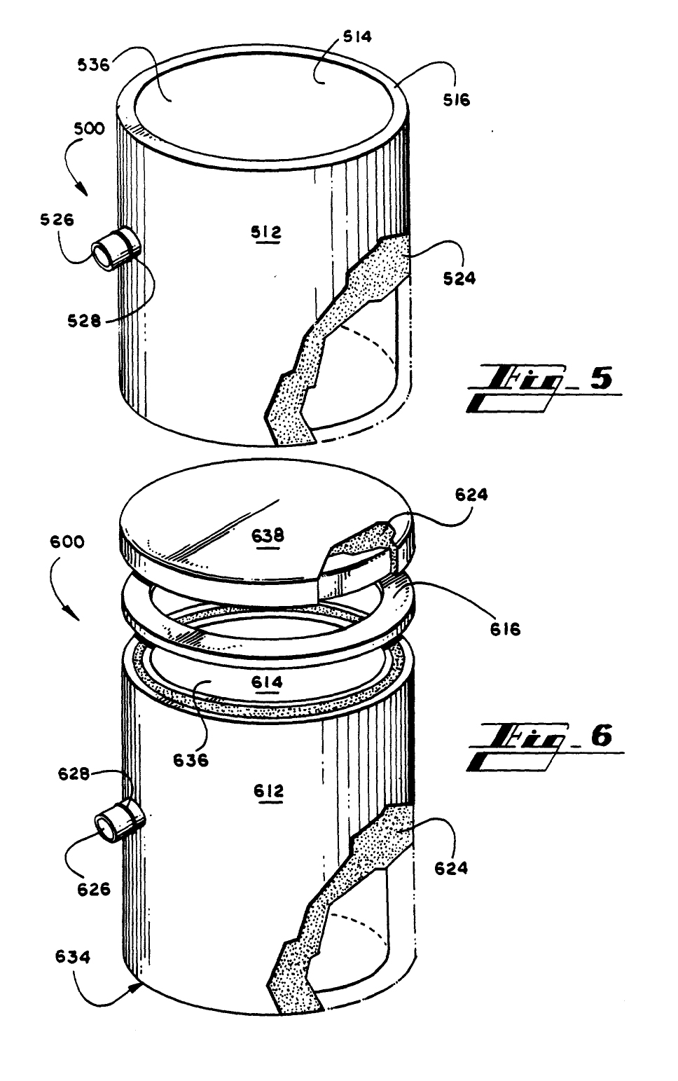

With reference to FIG. 5, in a third preferred embodiment, provided is insulated barrier 500 in the form of a round or cylindrical enclosure, which may comprise a continuous-wall structure. Insulated barrier 500 comprises first gas impermeable wall 512, second gas impermeable wall 514, adjoining surface 516, core material 524 comprising an open-cell structure, port 526 through which a vacuum may be drawn, and optionally a vacuum breach sensor 528 held within insulated barrier 500 or port 526 by which the presence of atmospheric oxygen may be detected. In such form, and with the use of core material 524 formed in situ, precursors to core material 524 may be injected into the space, or cavity between the gas impermeable walls 512, 514, and adjoining surface 516, and then formed. Alternatively, holes, slots, or optionally removable portions of the gas impermeable walls 512, 514, and adjoining surface 516, may be provided which assist formation of the core material 524. Advantageously, port 526 may be used for filling the space between the walls and for subsequent formation of the core material 524. When core material 524 has been formed, the insulated barrier 500, along with core material 524, is evacuated and sealed. Advantageously to this form, insulated barrier 500 may be constructed so as to include a central cargo or storage cavity 536, the end result looking much like a conventional cylindrical container, but having thickened walls, and being fully suitable for the carrying of a payload requiring rigorous temperature control. This container form also allows for a single seam instead of the twelve seams that are inherent in a box formed from panels.

Shown at FIG. 6 is an alternate form of construction of the third preferred embodiment of the present invention in the form of a cylindrical enclosure, intended to be used in association with a core material not formed in situ. Accordingly, insulated barrier 600 comprises a cylindrical enclosure, similar in overall form and material to that described above, comprising first gas impermeable wall 612, second gas impermeable wall 614, capping portion 616, core material 624 comprising an open-cell structure, port 626 through which a vacuum may be drawn, and optionally a vacuum breach sensor 628 held within insulated barrier 600 or port 626 by which the presence of atmospheric oxygen may be detected. Accordingly, walls 612, 614, in combination, form bottom portion 634. In such form, core material 624 is placed into bottom portion 634, formed and/or compacted if necessary, and capping portion 616 is placed thereon. Bottom portion 634 and capping portion 616 are then sealed. Insulated barrier 600, along with core material 624, is evacuated and sealed. Again, advantageously to this form, insulated barrier 600 may be constructed so as to include a central cargo or storage cavity 636, cavity 636 being fully suitable for the carrying of a payload requiring rigorous temperature control. As discussed in further detail herein below, lid 638, fabricated in accordance with the materials and methods of the present invention, may be provided to enclose storage cavity 636. This container form also allows for a single seam instead of the twelve seams that are inherent in a box formed from panels.

In accordance with a method of the present invention, an insulated barrier may be prepared by providing a gas impermeable enclosure having at least one space, or cavity, therein and a gas evacuation port. With the use of a core material formed in situ, the precursors for a core material are injected into a space or cavity between the walls of the gas impermeable enclosure, and then formed. The evacuation port optionally may be used for forming the core material. When the core material has been formed, the enclosure, along with the core material, is substantially evacuated of gas and sealed. Optionally, an oxygen vacuum breach sensor is provided within a cavity space or the evacuation port.

In accordance with an alternate method of the present invention, used in association with a core material not formed in situ, an insulated barrier may be manufactured by providing a gas impermeable enclosure having at least one space or cavity therein, forming a bottom portion, a capping portion, and a gas evacuation port. The core material is placed into the bottom portion of the enclosure, formed and/or compacted if necessary, and the capping portion is placed thereon. The bottom portion and the capping portion are then sealed. The enclosure, along with the core material, is substantially evacuated of gas and sealed. Optionally, an oxygen vacuum breach sensor is provided within the cavity space or the evacuation port.

When the insulated barrier of the present invention is provided in a form having a central cargo or storage cavity, such as a shipping box or cylinder, a refrigerator, or the like, a lid, top, or door-like construct, best seen as lid 438 in FIG. 4 or as lid 638 in FIG. 6, may be provided to enclose the storage cavity 436, 636. With such an arrangement, it now will be apparent that the lid, top, or door-like construct preferably is fabricated in accordance with the materials and methods of the present invention.

It will now be apparent that the insulated barrier of the present invention advantageously may be used for production of portable coolers, insulated beverage containers, refrigerators, biomedical shipping containers, building walls, water heaters and the like. Through the use of appropriate insulating materials such as those described hereinabove, appropriately low internal pressures, and appropriately opacified materials, the insulated barriers of the present invention may operate under conditions of extreme cold or heat, and even under cryogenic conditions, while maintaining those conditions for periods of time heretofore unachievable.

It is readily apparent that, not only does the insulated barrier of the present invention offer benefits in temperature control, it provides ancillary benefits such as reduced transportation and staging costs, reduced refrigerant costs, increased thermal insulation, increased cargo space with respect to effective refrigerant volumes, decreased package sizes and weights per effective insulation unit, along with attendant environmental benefits in each category.

In order that this invention may be better understood, the following examples are set forth.

### EXAMPLES

Preparation of Inorganic Coated Plastic

Blow molded box-like polyethylene terephthalate glycol (Eastar 6763 PETG Copolymer) containers, with inner and outer walls approximately 0.060 inches thick, were provided with outer dimensions of approximately 15 in.×10 in.×9 in. and inner dimensions of approximately 13 in.×8 in.×6 in. in accordance with FIG. 3. An inorganic coating was then applied in accordance with U.S. Pat. Nos. 5,516,555; 5,904,952; 6,112,695 and 6,180,191. This provided an insulated barrier container with only 28 inches of seam whereby the solid thermal conductivity of the gas-impermeable barrier was approximately 21 mW/m*K. A comparable container made from flat panels would consist of approximately 116 inches of seams.

Preparation of Vacuum Insulated Container

The container described above was provided with a port located on the bottom outside surface as indicated by FIG. 3, wall segment 312e. The core material was formed within the walls of the container in accordance with U.S. patent application Ser. Nos. 09/809,793 and 09/972,163. Precursor chemicals for the core material were poured into the barrier walls of the container and allowed to cure. Holes were drilled at the top flange of the container as indicated by FIG. 3, surfaces 316, 318, 320 and 322, to allow for drying of the cured precursor materials and formation of the core material within the barrier walls. The holes were then plastic welded closed and the container was evacuated through the port, such that the interior space of the barrier walls was maintained under a pressure of approximately 100 mTorr.

Preparation of Vacuum Breach Sensor

A stock solution was prepared by dissolving 0.094 g of New Methylene Blue (Aldrich Chemical Co.) in 50 mL water. An aliquot of the stock solution (0.3 g) was added to a glass vial equipped with a serum cap, followed by 2 g ethanol, 0.5 g triethylamine and 0.5 g propanal. The resulting dark blue solution was immersed in a −78° C. cooling bath, degassed by piercing the serum cap with a needle interfaced to a vacuum system, and back-filled with a nitrogen atmosphere. The blue solution was allowed to stir for 18 hours at which point the color changed to a much lighter blue color. Then, 1 mL of N-butyl-N′-methylimidazolium chloride (Aldrich Chemical Co.) and 0.5 g each of triethylamine and propanal were added. The solution was degassed as before and allowed to stir under nitrogen until the blue color gave way to a light yellow-orange color. In general, the triethylamine/propanal treatment was used as necessary to reduce the dye to the leuco form. At this time, the solution exhibited a pale yellow or light orange color.

Testing Methods and Results

The vacuum insulated container described above was filled with 2.2 kilograms of dry ice and a fiberglass mat was placed on top. The temperature was measured using a thermocouple located half-way down the inner wall of the vessel, and the ambient temperature of the room was also monitored using a separate thermocouple. The pressure of the interior space of the container walls was approximately 20 mTorr and the container was cooled to approximately −77° C. with the dry ice. After 133 hours, the temperature recorded by the inner thermocouple had increased by approximately 7° to −70° C. At this time, the container was opened and found to contain approximately 300 grams of dry ice. From these data it was calculated that the overall thermal conductivity of the container had an upper limit of about 4.4 mW/m*K.

To test the performance of the vacuum indicator, a vial of the vacuum breach sensor described above was opened to air. Within five minutes the surface of the viscous liquid began to develop a blue-green color. Within 30 minutes the entire solution was a deep blue-green color. A sample held at a pressure of approximately 0.1 Torr retained its pale yellow-orange color indefinitely.

While particular materials, formulations, operational sequences, process parameters, and end products have been set forth to describe and exemplify this invention, such are not intended to be limiting. Rather, it should be noted by those ordinarily skilled in the art that these disclosures are exemplary only and that various other alternatives, adaptations, and modifications may be made within the scope of the present invention. Accordingly, the present invention is not limited to the specific embodiments illustrated herein, but is limited only by the following claims.

All references cited within the body of the instant specification are hereby incorporated by reference in their entirety.

We claim:

1. An insulated barrier comprising:
(a) a first substantially gas impermeable rigid wall;
(b) a second substantially gas impermeable rigid wall;
(c) adjoining portions between said first and second walls that create an entirely closed and substantially hermetically sealed structure; and
(d) a core material between the walls that supports the walls of the structure, comprising a substantially open-cell structure or composition;
wherein said core material is formed in situ within said structure.

2. An insulated barrier comprising:
(a) a first substantially gas impermeable rigid wall;
(b) a second substantially gas impermeable rigid wall;
(c) adjoining portions between said first and second walls that create an entirely closed and substantially hermetically sealed structure; and
(d) a core material between the walls that supports the walls of the structure, comprising a substantially open-cell structure or composition;
wherein said first substantially gas impermeable rigid wall, said second substantially gas impermeable rigid wall, and said adjoining portions comprise a plastic coated with a metal oxide coating.

3. An insulated barrier comprising:
(a) a first substantially gas impermeable rigid wall;
(b) a second substantially gas impermeable rigid wall;
(c) adjoining portions between said first and second walls that create an entirely closed and substantially hermetically sealed structure; and
(d) a core material between the walls that supports the walls of the structure comprising a substantially closed-cell structure or composition;
wherein said first substantially gas impermeable rigid wall, said second substantially gas impermeable rigid wall, and said adjoining portions comprise a plastic coated with a metal oxide coating; and
wherein said closed-cell structure or composition is a powder or granular, provided that said closed-cell structure or composition is not foam glass.

4. The insulated barrier according to claims 2 or 3, wherein said metal oxide is a silicon oxide.

5. The insulated barrier according to any one of claims 1-3, further comprising a port through which a vacuum may be drawn.

6. The insulated barrier according to any one of claims 1-3, further comprising a vacuum breach sensor within the insulated barrier that detects atmospheric oxygen.

7. The insulated barrier according to claim 5, further comprising a vacuum breach sensor within the insulated barrier that detects atmospheric oxygen.

8. The insulated barrier according to claim 6, wherein said vacuum breach sensor comprises a nonaqueous ionic liquid and an indicator.

9. The insulated barrier according to claim 7, wherein said vacuum breach sensor comprises a nonaqueous ionic liquid and an indicator.

10. The insulated barrier according to claim 1, wherein said first and second walls, and said adjoining portions, comprise a composite of an organic substrate coated with an inorganic matrix.

11. The insulated barrier according to claim 10, wherein said organic substrate is plastic.

12. The insulated barrier according to claim 10 or 11, wherein said inorganic matrix is a metal oxide.

13. The insulated barrier according to claim 12, wherein said metal oxide is a silicon oxide.

14. The insulated barrier according to claim 10, wherein the organic substrate portion of said composite comprises the outside surface of said barrier.

15. The insulated barrier according to claims 1 or 2, wherein said core material is a small pore area material.

16. The insulated barrier according to claim 15, wherein said small pore area material is an organic, small pore area material.

17. The insulated barrier according to claim 15, wherein said small pore area material is a low density microcellular material.

18. The insulated barrier according to claim 16, wherein said organic, small pore area material is a low density microcellular material.

19. The insulated barrier according to claim 17, wherein said low density microcellular material is an aerogel.

20. The insulated barrier according to claim 18, wherein said low density microcellular material is an aerogel.

21. The insulated barrier according to any one of claims 1-3, wherein said core material has a thin film form.

22. The insulated barrier according to claim any one of claims 1-3, wherein said core material has a granular form.

23. The insulated barrier according to claim any one of claims 1-3, wherein said core material has a monolithic form.

24. A process for manufacture of an insulated barrier, comprising the steps of:
(a) providing a substantially gas impermeable enclosure having at least one space or cavity therein and a gas evacuation port;
(b) introducing into said cavity a core material comprising a substantially open-cell structure or composition; and
(c) substantially evacuating said cavity, along with said core material.

25. The process according to claim 24, further comprising the step of compacting said core material prior to evacuation of the cavity.

26. The process according to claim 24, further comprising the step of using said evacuation port for drying the core material.

27. A process for manufacture of an insulated barrier, comprising the steps of:
(a) providing a substantially gas impermeable enclosure having at least one space or cavity therein and a gas evacuation port;
(b) introducing into said cavity a core material comprising a substantially open-cell structure or composition;
(c) placing a substantially gas impermeable capping portion over said gas impermeable enclosure; and
(d) substantially evacuating said cavity, along with said core material.

28. The process according to any one of claims 24, 26 or 27, wherein said cavity contains a vacuum breach sensor comprising a nonaqueous ionic fluid and an indicator.

29. The process according to any one of claims 24, 26 or 27, wherein said substantially gas impermeable container comprises a composite of an organic substrate coated with an inorganic matrix.

30. The process according to claim 29, wherein said organic substrate is plastic and wherein said inorganic matrix is a metal oxide.

31. The process according to claim 30, wherein said metal oxide is a silicon oxide.

32. A vacuum breach sensor for detecting atmospheric oxygen, comprising a nonaqueous ionic fluid and an indicator.

33. The vacuum breach sensor according to claim 32, wherein said nonaqueous ionic fluid is N-butyl-N′-methylimidazolium chloride.

34. The vacuum breach sensor according to claim 32, wherein said indicator is selected from the group consisting of indigo dyes and thiazine dyes.

35. The vacuum breach sensor according to claim 34, wherein said dye is New Methylene Blue.

36. A vacuum breach sensor for detecting atmospheric oxygen, comprising a zinc oxide battery connected to a light-emitting diode or audible speaker.

37. An insulated barrier comprising a vacuum breach sensor, wherein said vacuum breach sensor is as defined in claims 32 or 36.
